(19) United States
(12) Patent Application Publication
(10) Pub. No.: US 2001/0020957 A1
(43) Pub. Date: Sep. 13, 2001

(54) Apparatus comprising a display screen and method of displaying information

(76) Inventor: Nicolas Ringot, Le Mans (FR)

Correspondence Address: Michael E. Marion, c/o U.S. PHILIPS CORPORATION, Intellectual Property Department, 580 White Plains Road, Tarrytown, NY, 10591, US

(21) Appl. No.: 09/790,182

(22) Filed: Feb. 22, 2001

(30) Foreign Application Priority Data
Feb. 23, 2000 (FR) 0002265

(51) Int. Cl. G06F 3/14

(52) U.S. Cl. 345/810; 345/817

(57) ABSTRACT

This apparatus comprises a display screen (3) for showing sections of a menu and/or information by influencing the keys (12, 13, 14, 15, 16 and 17—FIG. 1).

For being suitable for the various display modalities, the information shown is arranged according to a layout of said screen divided into areas (Z1, Z2, Z3 and Z4). If need be, certain of these areas may be combined.

### DESCRIPTION

The invention relates to an apparatus comprising a display screen for showing sections of a menu and/or information by influencing keys.

The invention has interesting applications when much information is to be displayed on a screen having small dimensions. This is notably the case when the apparatus is a mobile radiotelephone. This showing of information becomes a considerable problem with the WAP system (Wireless Application Protocol). One is furthermore confronted with problems of navigation to go from one series of information to the next. On this subject the website: http://www.wapforum.org/ could be consulted.

The invention thus also relates to a method of showing information on a screen having a rather small size and of navigating among all the information to be displayed.

Such an apparatus is known from European patent document filed under no. 99203507.1. Although this apparatus is satisfactory, it is not very well adapted for the display and navigation imposed by the WAP system.

The present invention proposes an apparatus of the type defined in the opening paragraph, which is particularly adapted to said navigation without the need for too many additional keys and with the possibility of navigation with a single finger.

For this purpose, such an apparatus is characterized in that it furthermore includes means for displaying on this same screen information shown, arranged according to a layout of said screen divided into areas.

According to the invention, the information display and navigation method is characterized in that the screen is subdivided into various areas and that certain of these areas may be combined as a function of the information to be processed.

These and other aspects of the invention are apparent from and will be elucidated, by way of non-limitative example, with reference to the embodiment(s) described hereinafter.

In the drawings:

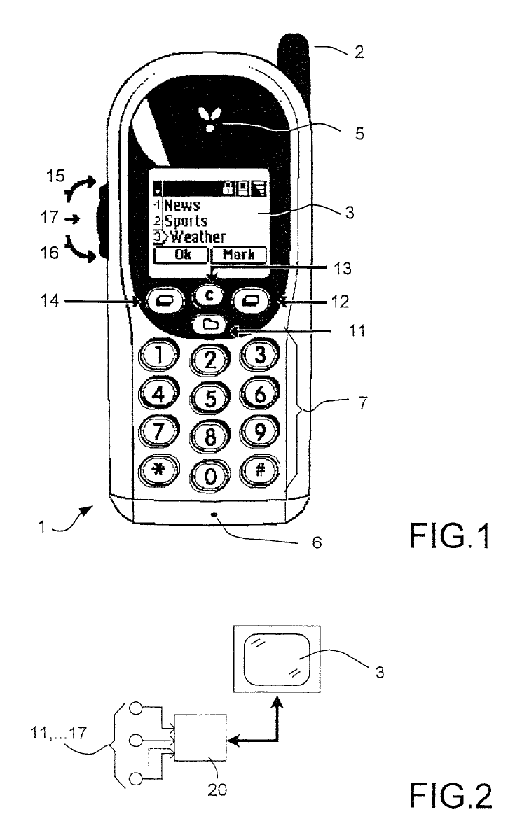

FIG. 1 shows an apparatus in accordance with the invention,

FIG. 2 shows the diagram of the apparatus shown in FIG. 1,

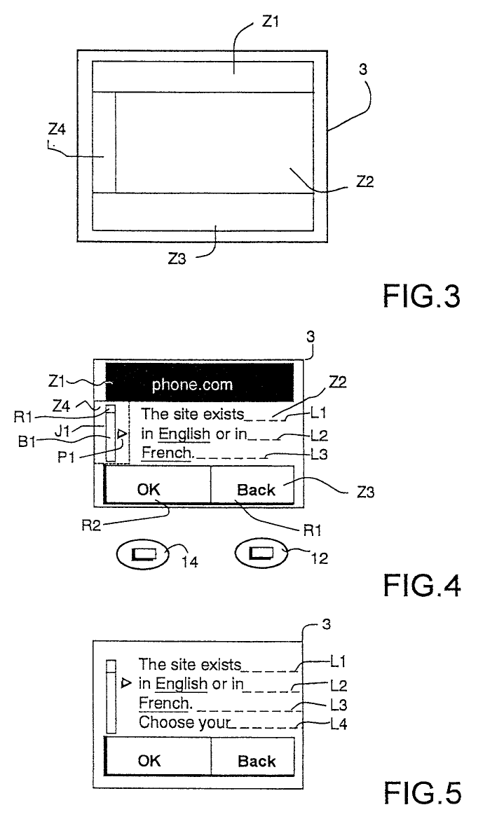

FIG. 3 shows the subdivision into areas of the screen of the apparatus,

FIG. 4 shows a first example of display on said screen,

FIG. 5 shows a second example of display on said screen,

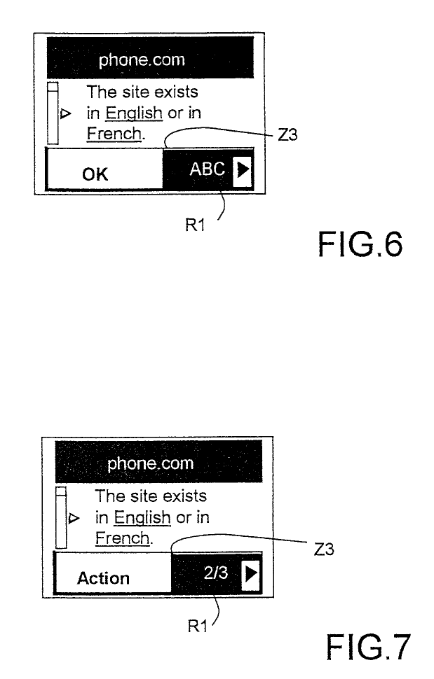

FIG. 6 shows a third example of display on said screen, and

FIG. 7 shows a fourth example of display on said screen.

In FIG. 1 is shown a mobile telephony apparatus formed by a housing 1 notably comprising an antenna 2, a screen 3, a loudspeaker 5, a microphone 6, a keypad 7 and various other operating buttons 11, 12, 13, 14, 15, 16 and 17. The buttons 11 to 14 are simple buttons which are to be pressed, whereas the buttons 15 and 16 simulate a rotation. Button 17 enables an option.

FIG. 2 shows an operation diagram of the apparatus. The elements which are held in common with those of the preceding Figure carry the same references. The operation of the invention is defined by a processor assembly 20 which, by analyzing the actions carried out on the keys (notably the keys 11 to 17, which are more involved in the invention), determines the information to be shown.

In accordance with the invention, for controlling the information to be displayed and in view of obtaining what is called a navigation among the information coming from a server that furnishes “WAP” information cited above, the screen is divided into various areas Z1 (or title area), Z2 (or information area), Z3 (or key area) and Z4 (or lift area), as this is shown in FIG. 3.

According to the described embodiment, the area Z1 is assigned to the title of the screen, the area Z2 to the showing of information coming from the WAP server or to sections of the menus that control the operation of the apparatus shown in FIG. 1. The area Z3 is assigned to the showing of the function of the buttons 12 and 14. In effect, depending on the circumstances, these buttons may have different functions or even suppressed functions, as this will be described in the following of the present memory. The area Z4 is the area assigned to a function known by the name of lift. It shows the level or an indication of the line of the information that is displayed.

FIG. 4 shows a first example of the screen. In this first example, the characters of the area 1 are written in a bright color, whereas the background has a dark color. The area Z1 is shown in video. The area Z2 shows several lines of information coming from a WAP server. In the example shown in this Figure, three lines L1, L2 and L3 are shown. The area Z3 shows the function of the keys 12 and 14. In this first example, a depression of the key 12, which is located below the rectangle R1, provokes the appearance of the preceding image. A depression of key 14, which is located below a rectangle R2 of the area Z3, permits to validate information shown in the area Z2 and indicated by an indicator situated in area Z4. This area Z4 comprises two elements: a gauge J1 and a pointer P1. The pointer P1 is aligned with the second line L2 of the information shown in area Z2. The gauge J1 is formed by a band B1 on which a marker R1 moves, which shows at what level the information displayed on the screen 3 is situated in the page of transmitted information. Thus, if they are the first lines that are displayed, the pointer will be in a high position as this is shown in the Figure. If they are the last lines, the pointer will be situated at the bottom of the band B1.

FIG. 5 shows a second example of placing the information. In this Figure, the area Z1 has been combined with the area Z2, so that the latter takes up more space. In this way it is possible to display four lines L1, L2, L3 and L4 in this area Z2.

FIG. 6 shows a third example of placing the information. In this example the rectangle R1 of the area Z3 is used for showing the possibility of invoking the “edition” mode.

FIG. 7 shows a third example of placing the information. In this example the rectangle R1 is again marked out for displaying other functions. It is used for selecting a hidden action when more than two actions are offered in the context proposed by the displayed WAP page.

Thus, by pressing the keys 12 and 14 and manoeuvring the keys 15 and 16, the navigation in the various menus coming from the WAP pages is facilitated to a large extent. This navigation may even be effected with a single finger. Thus this single finger may influence the keys 15 and 16 situated on the side of the housing to move the pointer P1.

It will thus be obvious that the apparatus according to the invention satisfies the specifications of the WAP system mentioned above.

1. An apparatus comprising a display screen for showing sections of a menu and/or information by influencing keys, characterized in that it furthermore includes means for displaying on this same screen information shown, arranged according to a layout of said screen divided into areas.

2. An apparatus as claimed in claim 1, characterized in that it includes navigation means for selecting and validating the information displayed by manipulating a single command.

3. An apparatus as claimed in claim 1 or 2, characterized in that it comprises means for combining areas to provide more space for at least another area.

4. An apparatus as claimed in one of the claims 1 to 3, characterized in that the areas are assigned, notably, a title area, an information area to display the information of a server, a button area and an indication area for providing an indication on the screen among the information provided by the server.

5. An apparatus as claimed in one of the claims 1 to 4, characterized in that it corresponds to WAP specifications.

6. An information display and navigation method, suitable for an apparatus as claimed in one of the claims 1 to 5, characterized in that the screen is subdivided into various areas and that certain of these areas may be combined with each other as a function of the information to be processed.
